(19) United States
(12) Patent Application Publication
(10) Pub. No.: US 2025/0219735 A1
(43) Pub. Date: Jul. 3, 2025

(54) IN-FIELD DROOP MEASUREMENT AND COMPENSATION FOR COHERENT OPTICAL TRANSCEIVER

(71) Applicants: Adam Herrmann, Dublin (IE); Anthony Kelly, Limerick (IE); Conor O'Keeffe, Cork (IE); Ricard Menchon Enrich, Barcelona (ES); Peter Kurahashi, Fort Collins, CO (US); Amy Whitcombe, Saratoga, CA (US); Sundar Krishnamurthy, Dublin, CA (US); Deepak Dasalukunte, Beaverton, OR (US)

(72) Inventors: Adam Herrmann, Dublin (IE); Anthony Kelly, Limerick (IE); Conor O'Keeffe, Cork (IE); Ricard Menchon Enrich, Barcelona (ES); Peter Kurahashi, Fort Collins, CO (US); Amy Whitcombe, Saratoga, CA (US); Sundar Krishnamurthy, Dublin, CA (US); Deepak Dasalukunte, Beaverton, OR (US)

(21) Appl. No.: 18/397,240

(22) Filed: Dec. 27, 2023

(51) Int. Cl. H04B 10/40; H04B 10/61

(52) U.S. Cl. CPC H04B 10/40; H04B 10/61

(57) ABSTRACT

A self-calibrating transceiver includes a set of digital to analog converters configured to process a comb calibration waveform, at least one IQ modulator configured to generate at least one optical signal comprising I and Q components operably coupled from the set of digital to analog converters. A receiver photonics circuit is configured to convert the coupled optical signals to electrical signals. The receiver photonics circuit includes a set of analog to digital converters coupled to convert the electrical signals to digital signals representative of the comb calibration waveform in cartesian IQ format. Processing circuitry is coupled to determine at least magnitude and/or phase of the digital signals and generate filter coefficients based on a comparison of at least magnitude and/or phase to the comb calibration waveform.

### TECHNICAL FIELD

Embodiments pertain to optical communications, and more specifically to coherent optical transceivers.

### BACKGROUND

Coherent optical transceivers have been used for high bandwidth long haul optical fiber links in trans-ocean fiber connections and are now finding use in other applications due to improved reach and capacity relative to other schemes. Other applications of coherent optical transceivers include optical datalinks with Low Earth Orbit (LEO) satellites that use reconfigurable optical modems. Such optical modems include optical and electrical components are subject to non-idealities and radio frequency (RF) losses, which may be corrected using filters. The coefficients to form the filters, however, should be accurately calculated.

### BRIEF DESCRIPTION OF THE DRAWINGS

FIG. 1 illustrates an exemplary functional block diagram of coherent optical transceiver circuitry in accordance with example embodiments.

FIG. 2 is a block diagram of a communication system that can include satellite communication systems in accordance with example embodiments.

FIG. 3 is a simplified block diagram illustrating operation of a transceiver configured in a photonics calibration mode in accordance with example embodiments.

FIG. 4 illustrates feedback paths in photonic sections of an example coherent optical transceiver in accordance with example embodiments.

FIG. 5 is a representation of a calibration comb waveform having multiple amplitude spikes at multiple FFT frequency bins in accordance with example embodiments.

FIG. 6 is a representation of a measured waveform derived by performing calibration on the transceiver in accordance with example embodiments.

FIG. 7 is a flowchart illustrating a method of calibrating an optical transceiver in accordance with example embodiments.

FIG. 8 is a flowchart illustrating a further method for calibrating an optical transceiver in accordance with example embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Low Earth Orbit (LEO) satellite modems are garnering attention. With companies like Amazon, StarLink, and OneWeb launching satellites for high-speed broadband connectivity, this is a growing market with significant innovation potential and commercial opportunity. DARPA (Defense Advanced Research Projects Agency) has responded to these developments by selecting several leading technology organizations, Intel being one, to contribute to its Space-BACN (Space-Based Adaptive Communications Node) program.

Space-BACN is a program to develop a low-cost, high-speed reconfigurable optical datalinks for use in LEO satellites. Intel's role in the program is to develop the reconfigurable optical modem portion, which is made up of a coherent optical transceiver, DSP/FEC accelerators, and a reconfigurable FPGA (Field Programmable Gate Array).

Coherent optical transceivers are made up of various analog components such as drivers, Mach-Zehnder interferometers, photodetectors, and 90° hybrids to name a few. There also may be various mixed signal DACs and ADCs which must be properly synchronized for the transceiver to function correctly. Therefore, calibration of these components is paramount to be successful in addressing this market. Components are grouped into optical and electrical integrated circuits (Photonics Integrated Circuit-PIC and Electrical Integrated Circuit-EIC).

Due to non-idealities and RF losses in these components, higher frequencies are attenuated with respect to lower frequencies. Passing the TX and RX signals through an FIR filter (or other/cascade thereof of filter types) can correct for this by attenuating the lower frequencies to achieve a flat response. The coefficients for the filters need to be calculated by measuring the uncorrected response for the I and Q components of the two polarizations (X, Y), for both TX and RX (eight unique paths). The same method can be used for other architectures (N unique paths).

Another artefact of the roll-off in filters is a distortion to the phase response. Ideally the pass band of the signal would experience a linear phase response or a constant group delay. A non-linear phase response or non-constant group delay is a result. The embodiments described herein can correct for such impairments also. Non-liner phase response can result in inter-symbol-interference and error vector magnitude distortion on the processed signal.

An improved transceiver includes a calibration path and circuitry that measures separate path droops in-field by allowing the droop in the various path components to be mathematically separated after being measured as a complete lineup.

In one example, a calibration signal or waveform in the form of a calibration comb waveform is sent through the N unique signal paths to generate N unique frequency responses. The magnitude and phase for each comb frequency (M comb frequencies) are measured and used to solve M set of N simultaneous equations to obtain the magnitude and phase response for each path component.

Performing these measurements in-field presents a challenge in that the stimulus for the measurement must come from the TX and must be measured in the RX via a calibration path, thus obtaining a measurement where both TX and RX droops are present. The calibration circuitry and digital signal processing using a M sets of N simultaneous equations, separates the droops to obtain independent filter coefficients to correct the droops during normal operation without specific equipment to separate these paths during measurement.

An overview of one context in which transceivers are used, along with background information on how such transceivers operate is provided, followed by a description and figures related to an improved transceiver that includes circuitry for performing calibration of transceivers utilizing calibration circuitry included with the transceivers.

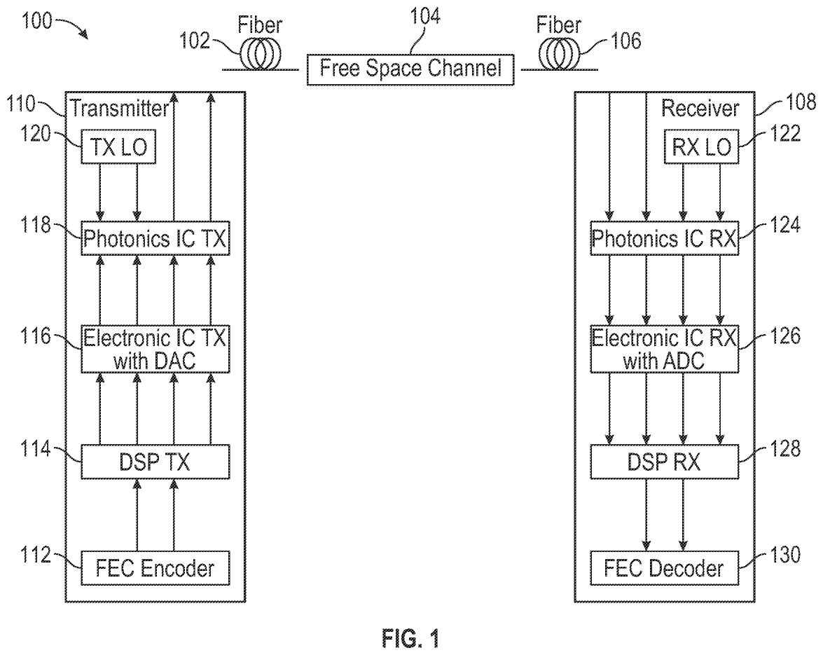

FIG. 1 illustrates a functional block diagram of coherent optical transceiver circuitry 100. The coherent optical transceiver circuitry 100 includes a transmit fiber 102 connecting a transmitter 110 to an optical aperture, which transmits an optical signal over a free space channel 104 (e.g., in a channel medium or channel media), and a receiver fiber 106 forwards the signal from a receiver optical aperture to a receiver 108.

The transmitter 110 includes a Forward Error Correction (FEC) encoder 112 configured to encode a bit stream. Digital signal processing (DSP) circuitry 114 is configured to frame, modulate, and generate the transmit waveform as a digital signal, which is supplied to transmitter electronics (EIC) circuitry 116 configured to convert the digital signal to an analog signal using a digital-to-analog (DAC) converter. Transmitter photonics (PIC) circuitry 118 is configured to convert the analog signal to an optical signal, which is modulated using an LO signal generated by transmit (TX) Local Oscillator (LO) circuitry 120.

Receiver 108 includes receive (RX) LO circuitry 122 to generate an LO signal matched to that of the TX LO circuitry 120 and thus permit coherent reception of the received optical signal. Receiver photonics circuitry (PIC) 124 is configured to convert the received optical signal to an analog electrical signal. Receiver electronics circuitry (EIC) 126 is configured to use an analog-to-digital (ADC) converter to convert the analog signal to a digital signal. DSP circuitry 128 is configured to correct impairments and demodulate the bits into a bit stream, and FEC decoder circuitry 130 is configured to decode the bit stream and in doing so fix many of the errors induced by the signal processing and channel.

Within a modem, the integrated circuit 116 and integrated circuit 126 can be the same circuit or include similar circuit elements. In some embodiments circuits 126, 128, 130, circuitry 116, circuitry 114 and encoder 112 functions can be integrated on the same package or otherwise be provided monolithically.

Coherent optical transceivers have been used for high bandwidth long haul optical fiber links for some time such as in trans-ocean fiber connections. More recently, the prevalence of coherent transceivers for other applications is growing due to the longer reach and better data-carrying capacity over legacy On-Off Key (OOK)-based intensity modulation/demodulation schemes. Coherent detection techniques can be used on fiber as well as free-space optic (FSO) propagation channel mediums, for example in terrestrial or satellite-to-satellite systems, or terrestrial-to-satellite systems. Coherent optical transceivers can be used to recover OOK modulation with a better link budget, however the vast majority of OOK deployments has relied on a direct intensity demodulation owing to the low complexity of the receiver.

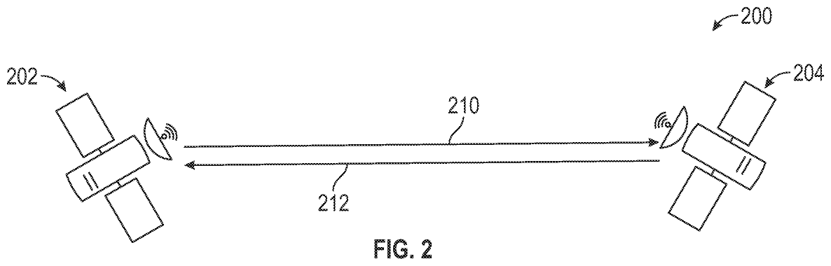

For example, coherent optical transceivers can be used in inter-satellite links (ISLs) used in systems similar to FIG. 2. FIG. 2 is a block diagram of a communication system 200 that can include satellite communication systems in accordance with some aspects. The system 200 can include two or more satellites 202, 204. While two satellites 202, 204 are shown, the communication system 200 can include any number of satellites or other communications devices. The satellites 202, 204 can be located, for example, at a geostationary or non-geostationary orbital location. Where a satellite 202, 204 is in a non-geostationary orbit, the satellite 202, 204 may be a LEO satellite.

Either or both satellites 202, 204 may include a spacecraft and one or more payloads (e.g., the communication payload, an imaging payload, etc.). The satellite 202, 204 may also include a command and data handling system and multiple power sources, such as batteries, solar panels, and one or more propulsion systems, for operating the spacecraft and the payload. The command and data handling system can be used, e.g., to control aspects of a payload and/or a propulsion system but is not limited thereto.

In some embodiments the optical link could also be a satellite to a terrestrial object such as an aircraft or a ground station. Each satellite 202, 204 can communicate with other satellites (e.g., each other or other satellites not shown in FIG. 2) over respective inter-satellite link (ISL) beams 210, 212. For example, the satellite 202 can send data to the satellite 204 over the ISL beam 210 and can receive data from the satellite 204 over the ISL beam 212. Links via beams 210, 212 can also be to other satellites not shown in FIG. 2, e.g., in a relay or mesh arrangement. ISL can use optical signals to communicate between the satellites 202, 204 similar to those described above with reference to FIG. 1.

As above, reconfigurable optical modems include one or more coherent optical transceivers, DSP/FEC accelerators, and a reconfigurable Field Programmable Gate Array (FPGA). The coherent optical transceiver contains various analog components such as drivers, Mach-Zehnder interferometers, photodetectors, and 90° hybrids. Various mixed signal DACs and ADCs are used that should be properly synchronized for the coherent optical transceiver to function correctly. The coherent optical transceiver components may be grouped into optical integrated circuits (Photonics Integrated Circuit-PIC) and electrical integrated circuits (Electrical Integrated Circuit-EIC).

Due to non-idealities and RF losses in the PIC and EIC, higher frequencies are attenuated with respect to lower frequencies. Passing the TX and RX signals through a finite impulse response (FIR) filter (or other/cascade thereof of filter types) may be able correct for the non-idealities and RF losses by attenuating the lower frequencies to achieve a flat response and/or correcting for non-linear phase distortion. As noted above, however, the coefficients for the filters should be calculated by measuring the uncorrected response for the I and Q components of the two polarizations (X, Y), for both the TX and RX signals (up to eight unique paths). The same method can be used for other architectures (N unique paths).

To measure the response for each path, separate path droops in-field are measured by allowing the droop in the various path components to be mathematically separated after being measured as a complete lineup. For example, a comb waveform may be sent through the N unique signal paths to generate N unique frequency responses. The magnitude and phase for each comb frequency (M comb frequencies) are then used to solve M set of N simultaneous equations to obtain the magnitude and phase response for each path component.

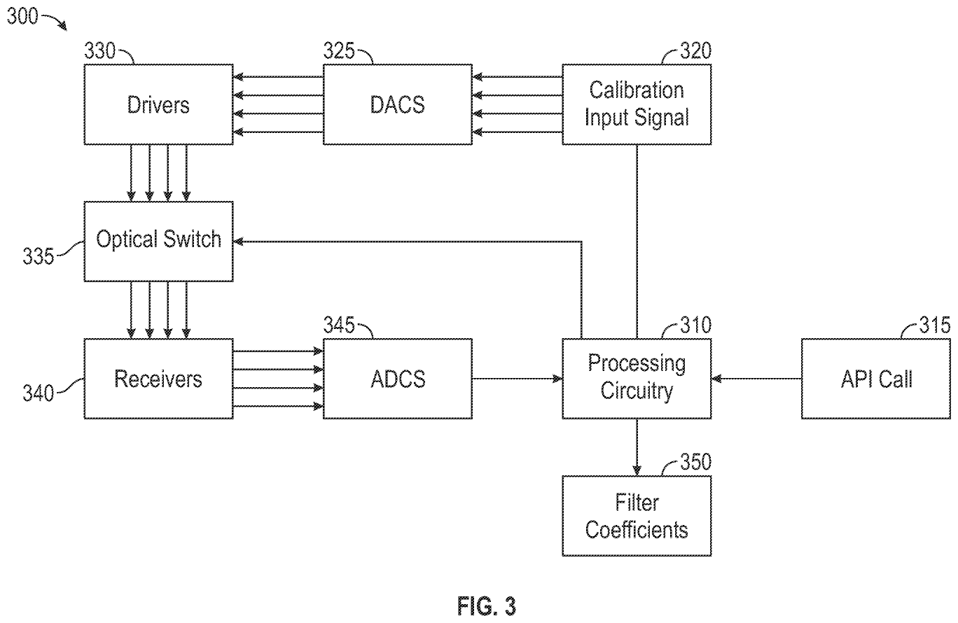

FIG. 3 is a simplified block diagram illustrating operation of a transceiver 300 configured in a photonics calibration mode. Some components used during normal operation are not show for simplicity of illustration of the calibration mode. Transceiver 300 includes processing circuitry 310 that receives an application programming interface (API) call 315 to begin performing calibration. Circuitry 310, such as a digital signal processor (DSP), microprocessor, or other suitable circuitry provide a calibration input signal 320, sch as an input comb waveform, to multiple digital to analog converters (DACs) 325. Drivers and Mach-Zehnder Interferometers (MZIs) 330 convert outputs of the DACs 325 to optical transmission signals, such as tx_xi, tx_xq, tx_yi, and tx_yq. An optical switch is sequentially controlled by circuitry 310 to provide different pairs of the optical transmission signals to receivers 340, which provide analog output signals, such as rx_xi, rx_xq, rx_yi, and rx_yq to analog to digital converters (ADCs) 345, which provide digital representations of the received signals to the circuitry 310.

Circuitry 310 controls the switch 335 to provide the following eight different paths in any order in one example:
1. tx_xi_rx_xi
2. tx_xq_rx_xq
3. tx_yi_rx_yq
4. tx_yq_rx_yi
5. tx_yq_rx_xi
6. tx_yi_rx_xq
7. tx_xi_rx_yi
8. tx_xq_rx_yq

The measured gain and phase responses on each path are then compared to desired gain and phase to enable the circuitry 310 to calculate filter coefficients 350 to counteract droop and/or phase distortion that can occur at higher frequencies for example. Fast Fourier Transforms (FFTs) may be used to calculate the gain/phase response at each of the frequencies of comb filter waveform. The coefficients 350 are calculated to ensure that the filters provide a level response within a desired level over a large range of frequencies, such as plus or minus 0.25 dB about the desired level.

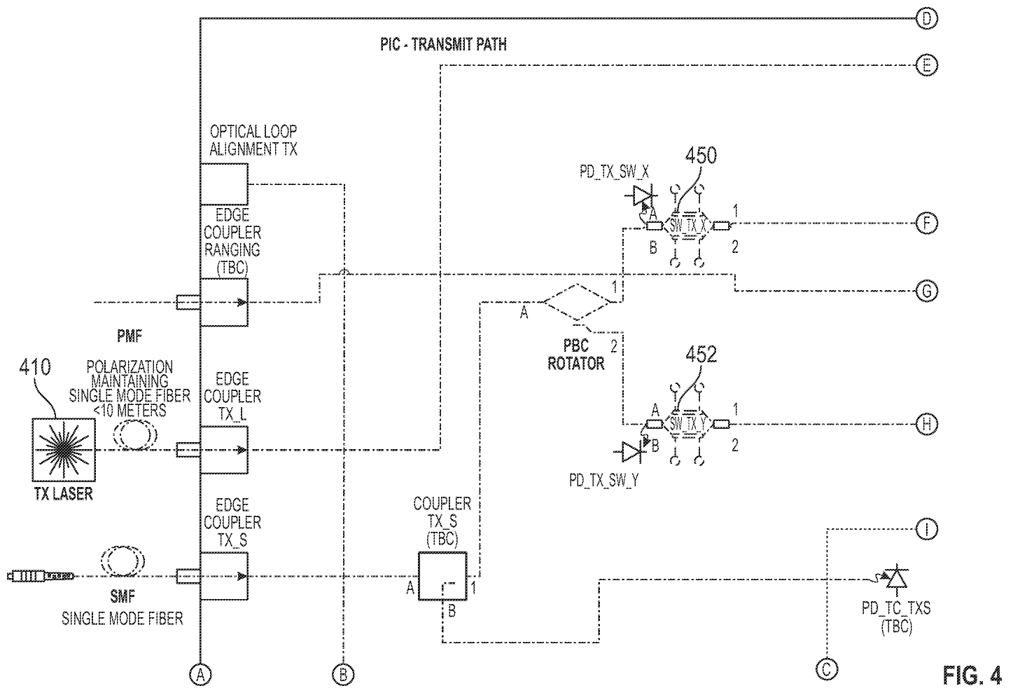

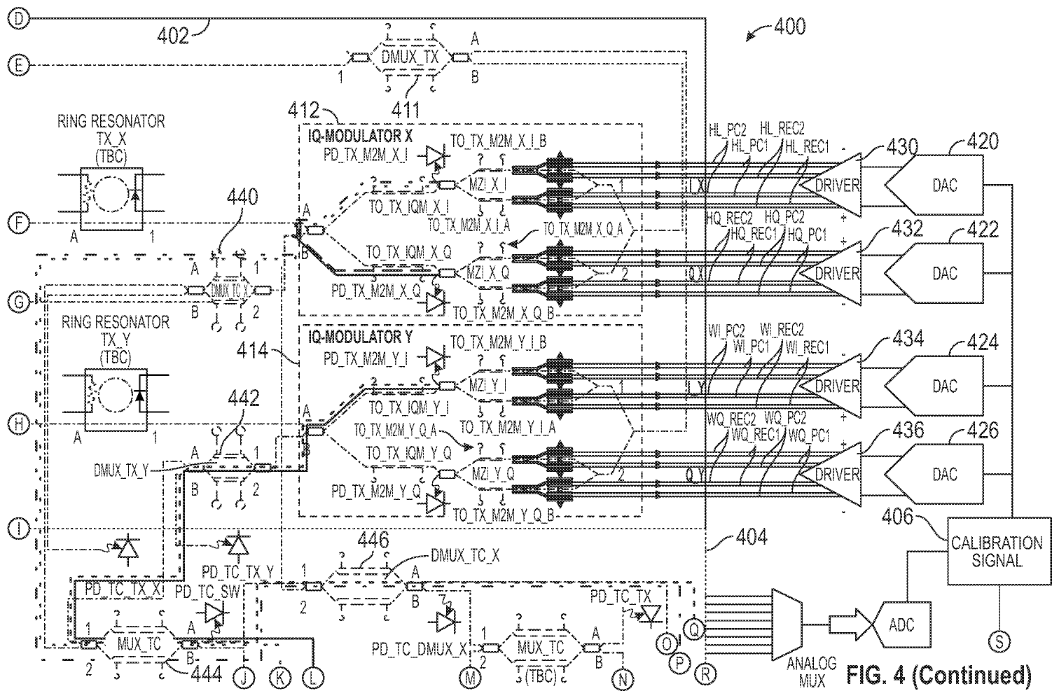

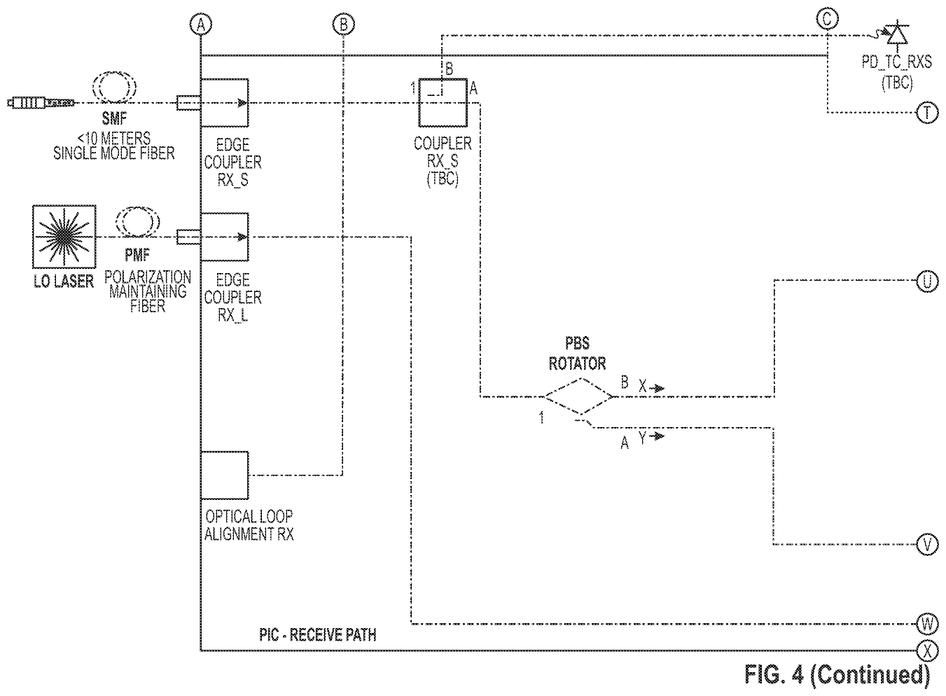

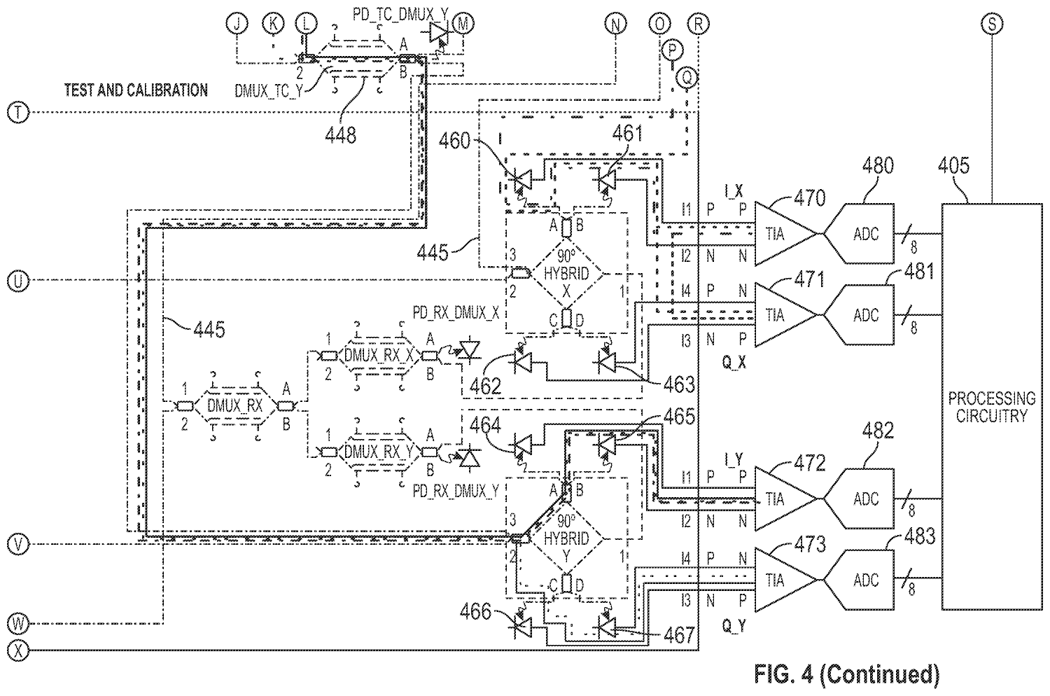

FIG. 4 illustrates feedback paths in photonic sections of an example coherent optical transceiver 400. Various portions of the coherent optical transceiver 400 may be implemented on different integrated circuits. For example, photonics circuits 402 and electronic circuits 404 can be on different integrated circuits. Test and calibration circuits can also be provided within electronic circuits 404.

The test and calibration circuits in electronic circuits 404 along with other processing circuitry 405, such as a digital signal processor may be used to reconfigure components of the photonics circuits 402 in order to perform calibration based on a comb waveform 406 that is sampled, converted to optical signals, received, and compared via processing circuitry 405 to expected signals to generate anti-droop filter coefficients.

In normal operation, a transmit (TX) laser 410 supplies an input optical signal through an optical transmit demultiplexer 411 to either a first in-phase/quadrature (IQ) modulator 412 (IQ-modulator X) or a second IQ modulator 414 (IQ-modulator Y).

The input optical signal is transformed into two components I and Q which is characterized by the signal on the output of a quadrature (Q) path being substantially 90° out of phase to the in-phase (I) path and substantially equal in power. The optical received signal can be split equally and added in phase to each of the I and Q path's 3 dB Hybrid outputs.

The TX laser 410 may serve as a local oscillator (LO) to be provided as an input to optical transmit demultiplexer 411 that splits the power in the TX laser signal into two separate photonic signals in separate waveguides. which is characterized by the signal on the output of a quadrature (Q) path being substantially 90° out of phase to the in-phase (I) path and substantially equal in power. The optical received signal can be split equally and added in phase to each of the I and Q paths.

Each of the first IQ modulator 412 and second IQ modulator 414 includes an I section and a Q section. Each of the I and Q sections include a Mach-Zehnder Interferometer (MZI) with two paths (also referred to as MZI_X_I and MZI_X_Q for the first IQ modulator 412 and MZI_Y_I and MZI_Y_Q for the second IQ modulator 414). Specifically, the input optical signal is supplied to each path of each MZI_X_I and MZI_X_Q of either the first IQ modulator 412 or the MZI_Y_I and MZI_Y_Q of the second IQ modulator 414.

In a calibration mode, an input comb waveform is provided to DACs 420, 422, 424, 426 coupled to drivers 430, 432, 434, 436 to provide electrical input signals to the first IQ modulator 412 and second IQ modulator 414.

Signals, such as amplitude modulated (AM) signals, may be generated from a first IQ digital-to-analog (DAC) pair 420, 424 and provided to a first driver pair 430, 432. The output of a first DAC 420 of the first IQ DAC pair 420, 422 is provided as an input to a first driver 430 associated with the first IQ modulator 412; the output of a second DAC 422 of the first IQ DAC pair 420, 424 is provided as an input to a second driver 430 associated with the first IQ modulator 412. The output of each driver 430, 432 may be provided to control the phases in the respective paths of the MZI_X_I and MZI_X_Q of the first IQ modulator 412.

The signals from the paths of the MZI_X_I of the first IQ modulator 412 are combined either constructively or destructively to provide the output of the MZI_X_I. Similarly, the signals from the paths of the MZI_X_Q of the first IQ modulator 412 are combined either constructively or destructively to provide the output of the MZI_X_Q. The output of the MZI_X_I and the output of the MZI_X_Q are combined to form an output of the first IQ modulator 412. The modulated output signal of the first IQ modulator 412 is provided from the TX path of the PIC to the test and calibration circuit through an X optical demultiplexer 440 in the photonics circuits, also referred to as PIC 402.

Similarly, for example, AM signals may be generated from a second IQ digital-to-analog (DAC) pair and provided to a second driver pair. The output of a first DAC of the second IQ DAC pair is provided as an input to a first driver associated with the second IQ modulator 414; the output of a second DAC of the second IQ DAC pair is provided as an input to a second driver associated with the second IQ modulator 414. The output of each driver may be provided to control the phases in the respective paths of the MZI_Y_I and MZI_Y_Q of the second IQ modulator 414.

The signals from the paths of the MZI_Y_I of the second IQ modulator 414 are combined either constructively or destructively to provide the output of the MZI_Y_I. Similarly, the signals from the paths of the MZI_Y_Q of the second IQ modulator 414 are combined either constructively or destructively to provide the output of the MZI_Y_Q. The output of the MZI_Y_I and the output of the MZI_Y_Q are combined to form an output of the second IQ modulator 414. The modulated output signal of the second IQ modulator 414 is provided from the TX path of the PIC 402 to the test and calibration circuit 404 through a Y optical demultiplexer 442 in the PIC 402.

The modulated output signals of the first IQ modulator 412 and the second IQ modulator 414 are provided to a combined optical switch 444 in the test and calibration circuit 402. The combined optical switch 444 then splits the signals into a first pair of signals and a second pair of signals. Each of the first and second pair of signals is then provided to an RX path 445 of the PIC 402 respectively through a first and second optical switch 446, 448 in the test and calibration circuit 402.

In one example, by successively configuring optical switches 440, 442, and 444 in calibration mode, N selected different combinations of signals may be serially provided by the test and calibration circuit 402. Switch 444 switches the X and Y polarizations to provide the different path combinations. Paths for each of the signals are represented by meandering lines 454, 455, 456, and 457. Such paths travers from a transmit portion of PIC 402, through the calibration circuitry 404, and through the receive portion of the PIC for measurement.

Each combination of signals is processed in the receive path to provide measured magnitudes and phases via photodiodes 460, 461, 462, 463, 464, 465, 466, 467, receive amplifiers 470, 471, 472, 473, and analog to digital converters (ADCs) 480, 481, 482, 483 and compared via the processing circuitry 405 to expected responses in order to generate anti-droop correction coefficients for anti-droop filters. In one example, the photodiodes comprise differentially configured pairs of photodiodes having outputs operably coupled to the ADCs. Once the anti-droop correction coefficients are applicated, transceiver 400 may operate in a normal manner to transmit and receive optical signals to and from another transceiver.

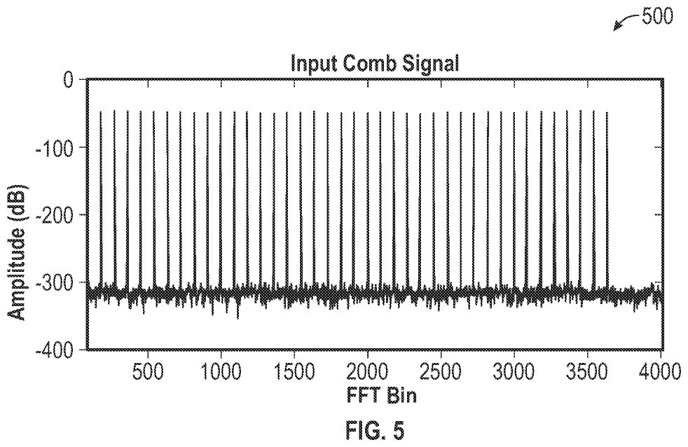

FIG. 5 is a representation of a calibration comb waveform 500 having multiple amplitude spikes at multiple FFT frequency bins. Each bin has a fairly consistent amplitude across multiple frequencies.

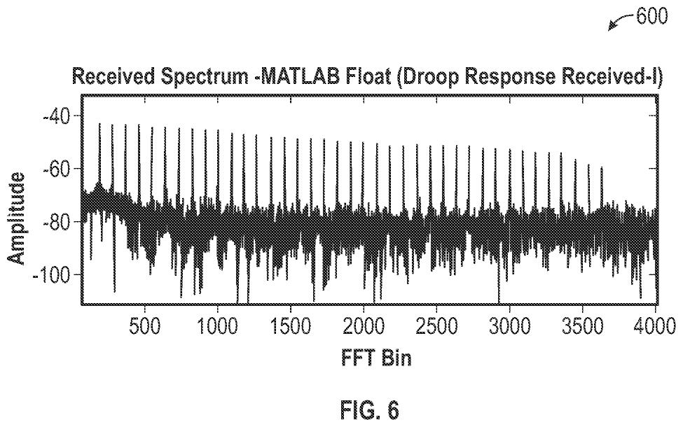

FIG. 6 is a representation of a measured waveform 600 derived by performing calibration on the transceiver. Again, multiple amplitude spikes at multiple FFT frequency bins are show, with the gain and phase drooping more with higher frequencies. The filter coefficients derived from the calibration are used to correct for such droop.

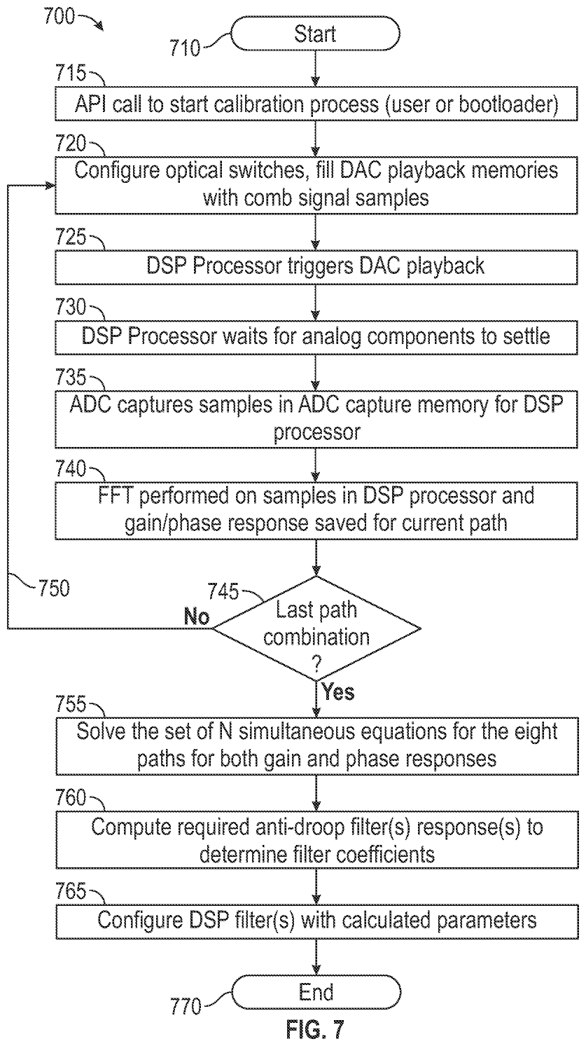

FIG. 7 is a flowchart illustrating a method 700 of calibrating an optical transceiver. Method 700 start at 710 and receives and API call at 715 to start the calibration process. A bootloader or user may make the API call in various examples. Operation 720 configures optical switches to provide optical paths and initiates provision of the calibration signal or waveform. In a first pass, a first path is configured at operation 720.

Memories of DACs may be filled with samples of the calibration waveform during operation 720 for a current path. Operation 725 triggers playback of the sampled signals in the DAC memories. At operation 730, after a fixed time to allow settling of analog components, ADCs capture the signals in a receiver portion of the transceiver. The signals may be stored in processing circuitry, such as a DSP processor. At 740, FFT is performed on the samples in the processing circuitry to obtain a gain and phase response of the received signals for a current path.

Operation 745 checks to see if all the paths have been processed. If not, control is passed back to operation 720 to configure the switches for the next path. If all paths have been processed, operation 755 solves for each frequency bin of the input comb (M), a set of N simultaneous equations to get magnitude and phase response of each individual path component. In one example, eight paths are processed to compare measured gain and phase to expected gain and phase. At operation 760, anti-droop filter coefficients are calculated. The filter coefficients may be calculated using an inverse DFT method, frequency sampling, or otherwise. The filter used in one example implementation is a FIR filter, however other filter types or cascades of filters can be used. An optimizer may be used to further tune the filter to provide a flat response and reduce group delay.

Digital filters are configured with the coefficients at operation 765, and method 700 ends at 770. The transceiver is now calibrated for droop and is ready to operate in a normal mode of operation to send and receive optical signals to and from other transceivers.\

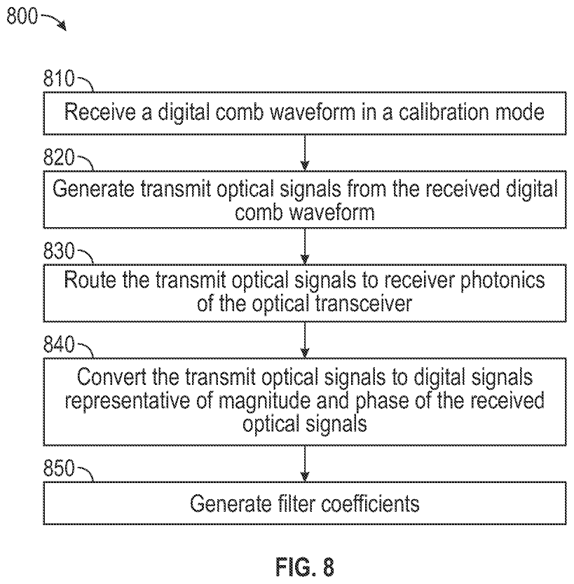

FIG. 8 is a flowchart illustrating a further method 800 for calibrating an optical transceiver. Method 800 begins at operation 810 by receiving a digital comb waveform in a calibration mode. Operation 820 generates optical signals from the processed digital comb waveform. Operation 830 routes the optical signals to a receive section of the optical transceiver. Operation 840 converts the optical signals to first electrical analog signals and then to digital IQ signals, the signals are further processed to determine magnitude and phase of the received signals. Operation 850 generates filter coefficients based on a comparison of received signals in comparison to the comb calibration signal.

In one example, transmit optical signals are generated from the processed digital comb waveform comprises generating I and Q components for two polarizations (X,Y). Filter coefficients may be generated by performing a Fast Fourier Transform (FFT) on the different pairs of the components to determine the amplitude and phase for each IQ receiver pair pair. IQ signals are signals described in cartesian format. The signal comprises an In-Phase and Quadrature Phase signal.

Converting the optical signals to digital signals may be performed by a 3 dB Hybrid coupler to provide the optical signals to differentially configured pairs of photodiodes having outputs operably coupled to analog to digital converters (ADCs).

In one example, the digital comb waveform has M comb frequencies, N different pairs are successively provided, and M sets of N simultaneous equations are solved to generate the filter coefficients. An adaptive filter algorithm is implemented based on the filter coefficients to process received optical signals in a normal mode.

Solving the simultaneous equations allows for the determination of response of the I and Q of the plurality of

### Additional Description and Examples

These several embodiments and examples can be combined using any permutation or combination. The Abstract is provided to allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

Example 1 is a self-calibrating transceiver includes a set of digital to analog converters configured to process a comb calibration waveform, at least one IQ modulator configured to generate at least one optical signal comprising I and Q components operably coupled from the set of digital to analog converters. A receiver photonics circuit is configured to convert the coupled optical signals to electrical signals. The receiver photonics circuit includes a set of analog to digital converters coupled to convert the electrical signals to digital signals representative of the comb calibration waveform in cartesian IQ format. Processing circuitry is coupled to determine at least magnitude and/or phase of the digital signals and generate filter coefficients based on a comparison of at least magnitude and/or phase to the comb calibration waveform.

Example 2 includes the transceiver of example 1 where the magnitude and/or phase of a plurality of comb spectrum lines is individually determined and where the comb waveform has M comb spectrum lines, N different pairs are successively provided, and M sets of N simultaneous equations are solved to generate the filter coefficients.

Example 3 includes the transceiver of any of examples 1-2 wherein the processing circuitry generates at least magnitude and/or phase of the received digital comb signals by performing a Fast Fourier Transform (FFT).

Example 4 includes the transceiver of any of examples 1-3 wherein the processing circuitry includes and application programming interface to receive a calibration signal and configuration to provide the comb calibration waveform to the set of digital to analog converters.

Example 5 includes the transceiver of any of examples 1-4 wherein the receiver includes a 3 dB Hybrid coupler to differentially configured pairs of photodiodes having outputs operably coupled to analog to digital converters (ADCs).

Example 6 includes the transceiver of any of examples 1-5, wherein the processing circuitry is configured to implement a filter to process received optical signals in a normal mode whose response is tuned by the generated filter coefficients.

Example 7 includes the transceiver of any of examples 1-6, wherein the receiver photonics include either a single or a dual-polarization receiver.

Example 8 includes the transceiver of any of examples 1-7, further including at least one optical switch, the at least one optical switch configured to a selectable couple the coupled optical signals to the at least one receiver photonic circuits in a calibration mode.

Example 9 includes the transceiver of any of examples 1-8, wherein the transceiver is included in least one of a channel media, a fiber system, a terrestrial free-space optics (FSO) system, a satellite-to-satellite FSO system or a combination thereof.

Example 10 is a method for calibrating an optical transceiver, the method including processing a received digital comb waveform in a calibration mode, generating transmit optical signals from the received digital comb waveform, selectively coupling, in a calibration mode, a modulator output to at least one photonics receiver circuit, converting, via the receiver photonics, the transmit optical signals to electrical signals, converting the electrical signals to digital signals in cartesian IQ format, processing the digital signals to generate magnitude and/or phase of the digital signals, and generating filter coefficients based on a comparison of at least magnitude and/or phase of the digital signals the comb calibration waveform.

Example 11 includes the method of example 10 wherein generating transmit optical signals from the received digital comb waveform includes generating I and Q components for either one or two polarizations.

Example 12 includes the method of example 11 wherein generating filter coefficients includes individually determining a magnitude and/or phase of a plurality of comb spectrum lines where the comb waveform has M comb spectrum lines, and N different pairs are successively provided, and solving M sets of N simultaneous equations are solved to generate the filter coefficients.

Example 13 includes the method of any of examples 11-12 wherein processing the digital signals to generate magnitude and/or phase of the digital signals utilizes a Fast Fourier Transform (FFT).

Example 14 includes the method of any of examples 10-13 wherein converting the transmit optical signals to digital signals is performed by a 3 dB Hybrid coupler to differentially configure pairs of photodiodes having outputs operably coupled to analog to digital converters (ADCs).

Example 15 includes the method of any of examples 10-14 and further including implementing a filter having a response tuned by the generated filter coefficients.

Example 16 includes the method of any of examples 10-15, wherein the optical transceiver is included in least one of a channel media, a fiber system, a terrestrial free-space optics (FSO) system, a satellite-to-satellite FSO system or a combination thereof.

Example 17 is a self-calibrating transceiver having photonic circuitry and electronic circuitry configured to implement a method including processing a received digital comb waveform in a calibration mode, generating transmit optical signals from the received digital comb waveform, selectively coupling, in a calibration mode, a modulator output to at least one photonics receiver circuit, converting, via the receiver photonics, the transmit optical signals to electrical signals, converting the electrical signals to digital signals in cartesian IQ format, processing the digital signals to generate magnitude and/or phase of the digital signals, and generating filter coefficients based on a comparison of at least magnitude and/or phase of the digital signals the comb calibration waveform.

Example 18 includes the transceiver of example 17 wherein generating transmit optical signals from the received digital comb waveform includes generating I and Q components for either one or two polarizations (X,Y).

Example 19 includes the transceiver of example 18 wherein generating filter coefficients includes individually determining a magnitude and/or phase of a plurality of comb spectrum lines where the comb waveform has M comb spectrum lines, and N different pairs are successively provided, and solving M sets of N simultaneous equations are solved to generate the filter coefficients.

Example 20 includes the transceiver of any of examples 17-19 wherein converting the transmit optical signals to digital signals is performed by a 3 dB Hybrid coupler to differentially configure pairs of photodiodes having outputs operably coupled to analog to digital converters (ADCs).

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code can be tangibly stored on one or more volatile or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A self-calibrating transceiver comprising:
a set of digital to analog converters configured to process a comb calibration waveform;
at least one IQ modulator configured to generate at least one optical signal comprising I and Q components operably coupled from the set of digital to analog converters;
a receiver photonics circuit configured to convert the coupled optical signals to electrical signals;
the receiver photonics circuit including a set of analog to digital converters coupled to convert the electrical signals to digital signals representative of the comb calibration waveform in cartesian IQ format; and
processing circuitry coupled to determine at least magnitude and/or phase of the digital signals and generate filter coefficients based on a comparison of at least magnitude and/or phase to the comb calibration waveform.

2. The transceiver of claim 1 where the magnitude and/or phase of a plurality of comb spectrum lines is individually determined and where the comb waveform has M comb spectrum lines, N different pairs are successively provided, and M sets of N simultaneous equations are solved to generate the filter coefficients.

3. The transceiver of claim 1 wherein the processing circuitry generates at least magnitude and/or phase of the received digital comb signals by performing a Fast Fourier Transform (FFT).

4. The transceiver of claim 1 wherein the processing circuitry includes and application programming interface to receive a calibration signal and configuration to provide the comb calibration waveform to the set of digital to analog converters.

5. The transceiver of claim 1 wherein the receiver includes a 3 dB Hybrid coupler to differentially configured pairs of photodiodes having outputs operably coupled to analog to digital converters (ADCs).

6. The transceiver of claim 1, wherein the processing circuitry is configured to implement a filter to process received optical signals in a normal mode whose response is tuned by the generated filter coefficients.

7. The transceiver of claim 1, wherein the receiver photonics comprise either a single or a dual-polarization receiver.

8. The transceiver of claim 1, further comprising at least one optical switch, the at least one optical switch configured to a selectable couple the coupled optical signals to the at least one receiver photonic circuits in a calibration mode.

9. The transceiver of claim 1, wherein the transceiver is included in least one of a channel media, a fiber system, a terrestrial free-space optics (FSO) system, a satellite-to-satellite FSO system or a combination thereof.

10. A method for calibrating an optical transceiver, the method comprising:
processing a received digital comb waveform in a calibration mode;
generating transmit optical signals from the received digital comb waveform;
selectively coupling, in a calibration mode, a modulator output to at least one photonics receiver circuit;
converting, via the receiver photonics, the transmit optical signals to electrical signals;
converting the electrical signals to digital signals in cartesian IQ format;
processing the digital signals to generate magnitude and/or phase of the digital signals; and
generating filter coefficients based on a comparison of at least magnitude and/or phase of the digital signals the comb calibration waveform.

11. The method of claim 10 wherein generating transmit optical signals from the received digital comb waveform comprises generating I and Q components for either one or two polarizations.

12. The method of claim 11 wherein generating filter coefficients comprises:
individually determining a magnitude and/or phase of a plurality of comb spectrum lines where the comb waveform has M comb spectrum lines, and N different pairs are successively provided; and
solving M sets of N simultaneous equations are solved to generate the filter coefficients.

13. The method of claim 11 wherein processing the digital signals to generate magnitude and/or phase of the digital signals utilizes a Fast Fourier Transform (FFT).

14. The method of claim 10 wherein converting the transmit optical signals to digital signals is performed by a 3 dB Hybrid coupler to differentially configure pairs of photodiodes having outputs operably coupled to analog to digital converters (ADCs).

15. The method of claim 10 and further comprising implementing a filter having a response tuned by the generated filter coefficients.

16. The method of claim 10, wherein the optical transceiver is included in least one of a channel media, a fiber system, a terrestrial free-space optics (FSO) system, a satellite-to-satellite FSO system or a combination thereof.

17. A self-calibrating transceiver having photonic circuitry and electronic circuitry configured to implement a method comprising:
processing a received digital comb waveform in a calibration mode;
generating transmit optical signals from the received digital comb waveform;
selectively coupling, in a calibration mode, a modulator output to at least one photonics receiver circuit;
converting, via the receiver photonics, the transmit optical signals to electrical signals;
converting the electrical signals to digital signals in cartesian IQ format;
processing the digital signals to generate magnitude and/or phase of the digital signals; and
generating filter coefficients based on a comparison of at least magnitude and/or phase of the digital signals the comb calibration waveform.

18. The transceiver of claim 17 wherein generating transmit optical signals from the received digital comb waveform comprises generating I and Q components for either one or two polarizations (X,Y).

19. The transceiver of claim 18 wherein generating filter coefficients comprises:
individually determining a magnitude and/or phase of a plurality of comb spectrum lines where the comb waveform has M comb spectrum lines, and N different pairs are successively provided; and
solving M sets of N simultaneous equations are solved to generate the filter coefficients.

20. The transceiver of claim 17 wherein converting the transmit optical signals to digital signals is performed by a 3 dB Hybrid coupler to differentially configure pairs of photodiodes having outputs operably coupled to analog to digital converters (ADCs).
